(19) United States
(12) Patent Application Publication
(10) Pub. No.: US 2025/0054288 A1
(43) Pub. Date: Feb. 13, 2025

(54) UPDATING SYNTHETIC IMAGE LABELS USING NEURAL NETWORKS TO IMPROVE PERFORMANCE ON REAL-WORLD APPLICATIONS

(71) Applicant: NVIDIA Corporation, Santa Clara, CA (US)

(72) Inventors: Yuan-Hong LIAO, Toronto (CA); David Jesus ACUNA MARRERO, Toronto (CA); James LUCAS, Royston (GB); Rafid MAHMOOD, Mississauga (CA); Sanja FIDLER, Toronto (CA); Viraj Uday PRABHU, Atlanta, GA (US)

(73) Assignee: NVIDIA Corporation, Santa Clara, CA (US)

(21) Appl. No.: 18/366,394

(22) Filed: Aug. 7, 2023

(51) Int. Cl. G06V 10/82; G06V 20/70

(52) U.S. Cl. CPC G06V 10/82; G06V 20/70

(57) ABSTRACT

Various examples relate to translating image labels from one domain (e.g., a synthetic domain) to another domain (e.g., a real-world domain) to improve model performance on real-world datasets and applications. Systems and methods are disclosed that provide an unsupervised label translator that may employ a generative adversarial network (GAN)-based approach. In contrast to conventional systems, the disclosed approach can employ a data-centric perspective that addresses systematic mismatches between datasets from different sources.

### CROSS-REFERENCE TO RELATED APPLICATIONS

None.

### BACKGROUND

Synthetic data is valuable for neural network training, but the disparities (including misalignments, variances, incongruities, incompatibilities, etc.) between synthetic and real-world datasets present machine learning challenges in real-world applications. Similarly, disparities can be present between two real-world datasets that further complicate the use and processing of these datasets as a collective whole. With respect to addressing the disparities between synthetic and real-world datasets, prior solutions approached the problem by (1) modifying loss functions and machine learning model architectures, or (2) translating images from the synthetic domain to the real-world domain. However, modifying loss functions and model architectures is very application- and setting-specific, and success in one application under a certain setting does not transfer well to another application, which naturally limits the ability to scale and adapt the techniques to additional and/or different applications. Also, translating images from the synthetic domain to the real-world domain does not consider whether a label in the synthetic domain is also applicable to the translated real-world domain.

### SUMMARY

Embodiments of the present disclosure relate to translating synthetic image labels to improve model performance on real-world datasets and applications. Systems and methods are disclosed that provide an unsupervised label translator that may employ a generative adversarial network (GAN)-based approach. In contrast to conventional systems, such as those described above, the disclosed approach can employ a data-centric perspective that addresses systematic mismatches between datasets from different sources.

As used herein, a “label” may refer to a bounding region (e.g., a box or other shape) outlining or otherwise surrounding one or more objects in an image. Label may refer to a semantic or panoptic identification or characterization of one or more objects in an image. Translating a label may refer to one or more modifications to a bounding region (e.g., resizing or otherwise changing a shape), and/or one or more modifications to a characterization (e.g., “flipping” or otherwise changing an identification or characterization) of the bounding region or an associated object for instance.

At least one aspect relates to a processor. The processor can comprise, or can be, one or more circuits. The one or more circuits can modify labels of the first images in the source dataset by using a model comprising a neural network and based at least on receiving a source dataset comprising first images. The one or more circuits can modify the labels by modifying bounding regions of the labels to obtain modified bounding regions. The one or more circuits can modify/update the labels of the first images using the modified bounding regions. The model can be updated (e.g., trained, optimized, augmented, or configured) using a generator to modify bounding regions in the first images. The generator can be updated using a discriminator to obtain a first score for the first images and the modified bounding regions, and a second score for second images in a reference dataset and bounding regions of the second images. Updating/training the model can comprise minimizing a first loss of the generator and a second loss of the discriminator, using the first score and the second score.

In various embodiments, one or more (e.g., each) label in the first images can be or can comprise a bounding region surrounding one or more objects. In various embodiments, modifying the label can comprise modifying the bounding region. In various embodiments, modifying the bounding region can comprise changing a shape or dimension of the bounding region. In various embodiments, the one or more circuits can modify the bounding region based on changes in pixels proximate to the bounding region.

In various embodiments, the source dataset can be or can comprise synthetic data. In various embodiments, the reference dataset can be or can comprise real data (“real” is hereby used interchangeably with “real-world” in this disclosure). In some embodiments, both the source dataset and the reference dataset comprise real data. In various embodiments, the second loss can be or can comprise a function to minimize differences between the first images and the second images.

In various embodiments, the one or more circuits can identify pixels proximate to the bounding regions of the first images. In various embodiments, the one or more circuits can modify, based on the identified pixels, the bounding regions of the first images.

In various embodiments, the model can be a generative adversarial network (GAN) model. In various embodiments, each label can comprise a semantic or panoptic characterization of the one or more objects in the bounding region. In various embodiments, each bounding region can include an identifiable object in the image.

Yet another aspect relates to a processor. The processor can comprise, or can be, one or more circuits. The one or more circuits can update (e.g., train, configure, establish) a model to modify labels of first images in a source dataset. Training/updating the model can comprise using a generator to modify bounding regions of the first images. Training/updating the model can comprise using a discriminator to obtain a first score for the first images and the modified bounding regions, and a second score for second images in a reference dataset and bounding regions of the second images. Training/updating the model can comprise minimizing a first loss of the generator and a second loss of the discriminator, using the first score and the second score.

In various embodiments, the source dataset can comprise, or can be, synthetic data, and the reference dataset can comprise, or can be, real data. In some embodiments, the source dataset can comprise, or can be, real data, and the reference dataset can comprise, or can be, real data. In some embodiments, the source dataset can comprise, or can be, images depicting synthetically-generated data, and the reference dataset can comprise, or can be, images of real objects or scenes. In various embodiments, the second loss can comprise, or can be, a function to minimize differences between the first images and the second images. In various embodiments, the one or more circuits can identify pixels proximate to the bounding regions of the first images, and modify the bounding regions of the first images, using or otherwise based on the identified pixels. In various embodiments, the model is a generative adversarial network (GAN) model.

In various embodiments, the one or more circuits can use the trained/updated model to modify the labels in the first images according to the modified bounding regions. In various embodiments, each label in the first images can comprise, or can be, a bounding region surrounding one or more objects. In various embodiments, modifying the label in an image in the source dataset can comprise, or can be, modifying the bounding region. In various embodiments, modifying the bounding region can comprise, or can be, changing a shape or dimension of the bounding region.

At least one aspect relates to a method. The method can comprise using a trained/updated model to modify labels of first images in a source dataset. Training/updating the model can comprise using a generator to modify bounding regions in the first images. Training/updating the model can comprise using a discriminator to obtain a first score for the first images and the modified bounding regions, and a second score for second images in a reference dataset and bounding regions of the second images. Training/updating the model can comprise minimizing a first loss of the generator and a second loss of the discriminator, using the first score and the second score.

Yet another aspect relates to a method. The method can comprise, or can consist of, using a generative adversarial network (GAN) model to modify bounding regions in synthetic images. The bounding regions can correspond to (e.g., surround) objects in the synthetic images. The GAN model can comprise, or can consist of, a generator and a discriminator. The generator can be configured to generate modified bounding regions. The discriminator can be configured to evaluate the modified bounding regions. In various embodiments, the generator can adjust data generation based on how well the discriminator is discriminating between real data and synthetic data (e.g., is able to correctly determine whether data being evaluated is real or synthetic).

In various embodiments, the processors, systems, and/or methods described herein can be implemented by, or can be included in, at least one of a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system for generating or presenting at least one of virtual reality, augmented reality, or mixed reality content; a system implemented using a robot; a system for performing conversational AI operations; a system for generating synthetic data; a system incorporating one or more virtual machines (VMs); a system implemented at least partially in a data center; or a system implemented at least partially using cloud computing resources.

### BRIEF DESCRIPTION OF THE DRAWINGS

The present systems and methods for translating synthetic image labels to improve model performance on real-world datasets and applications are described in detail below with reference to the attached drawing figures, wherein:

FIG. 1A is an illustration of an example autonomous vehicle, in accordance with some embodiments of the present disclosure;

FIG. 1B is an example of camera locations and fields of view for the example autonomous vehicle of FIG. 1A, in accordance with some embodiments of the present disclosure;

FIG. 1C is a block diagram of an example system architecture for the example autonomous vehicle of FIG. 1A, in accordance with some embodiments of the present disclosure;

FIG. 1D is a system diagram for communication between cloud-based server(s) and the example autonomous vehicle of FIG. 1A, in accordance with some embodiments of the present disclosure;

FIG. 2 is a block diagram of an example computing device suitable for use in implementing some embodiments of the present disclosure;

FIG. 3 is a block diagram of an example data center suitable for use in implementing some embodiments of the present disclosure; and

FIG. 4 is a flow diagram of an example process of generating and deploying a machine learning model, in accordance with some embodiments of the present disclosure.

### DETAILED DESCRIPTION

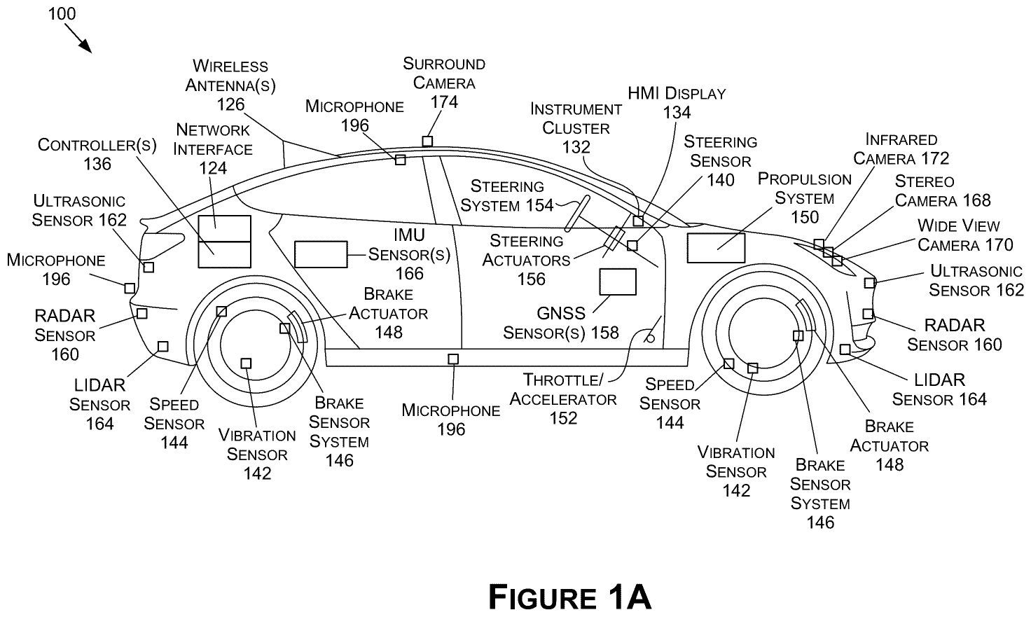

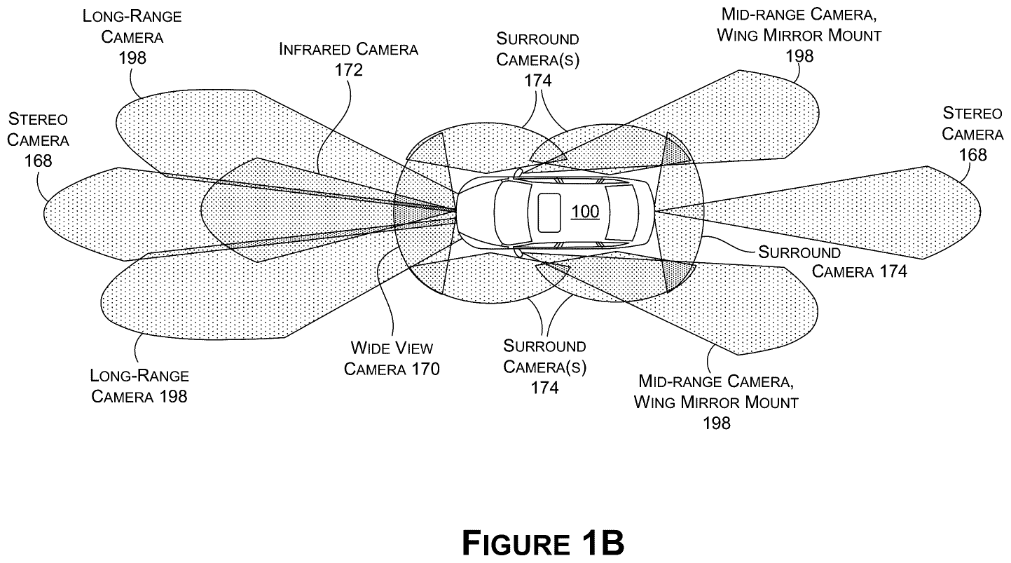

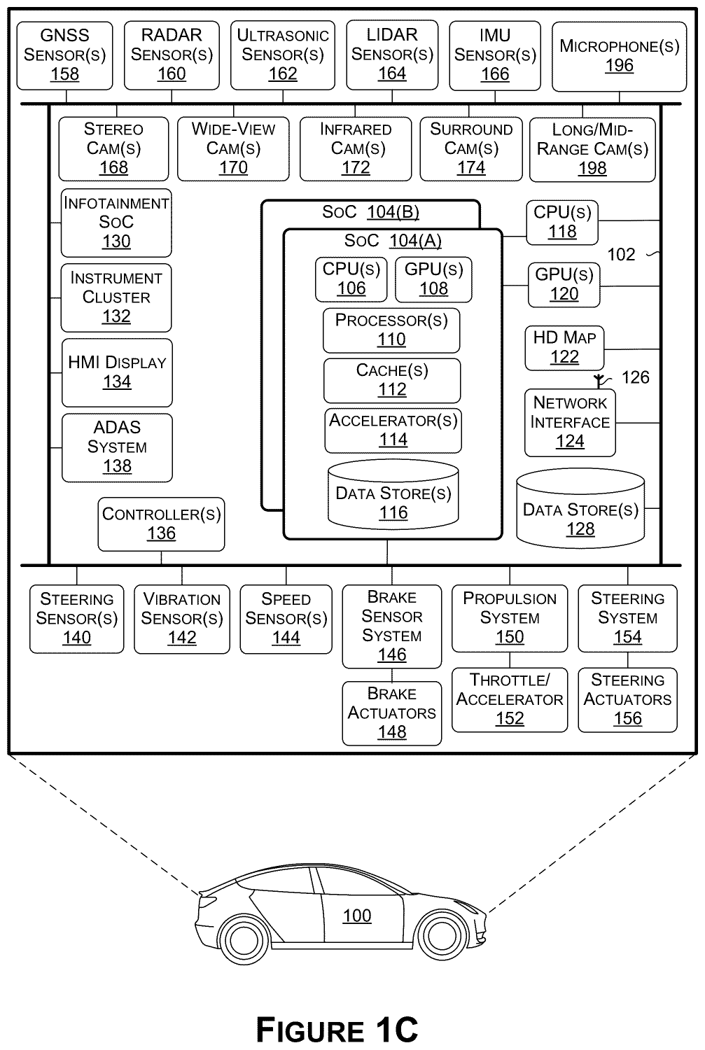

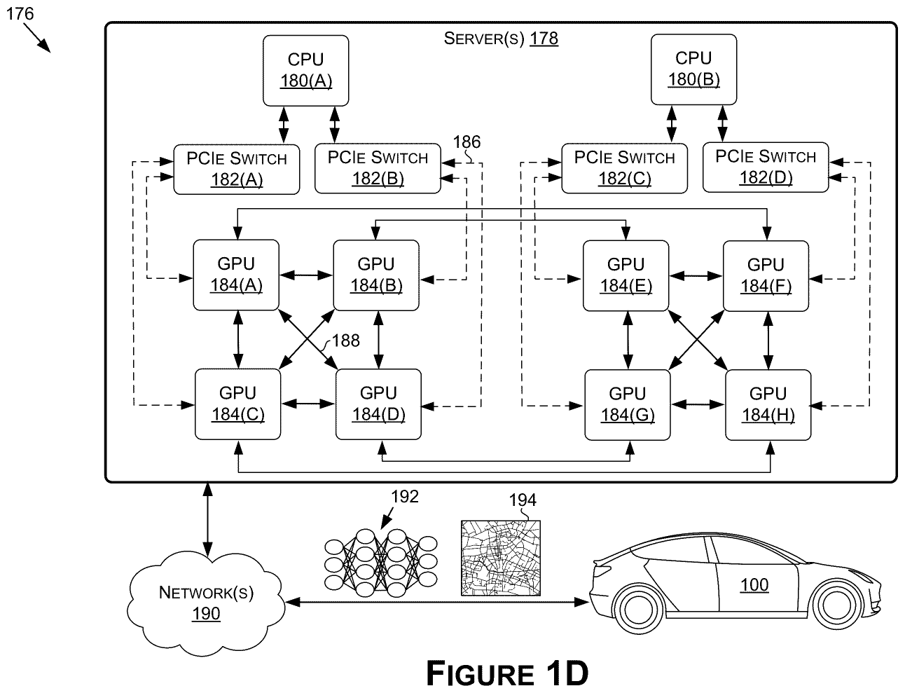

Systems and methods are disclosed related to translating (e.g., updating or modifying) image labels from a first domain (e.g., a source domain, such as a synthetic domain) to a second domain (e.g., a target domain, such as a real-world domain) to improve model performance on real-world datasets and applications. Although the present disclosure may be described with respect to an example autonomous vehicle 100 (alternatively referred to herein as “vehicle 100” or “ego-vehicle 100,” an example of which is described with respect to FIGS. 1A-1D), this is not intended to be limiting. For example, the systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to modifying labels in synthetic images for use in training/assisting vehicle perception systems, this is not intended to be limiting, and the systems and methods described herein may be used in augmented reality, virtual reality, mixed reality, robotics, security and surveillance, autonomous or semi-autonomous machine applications, and/or any other technology spaces where there is imaging data with labels to be potentially translated.

Certain machines operate in well-controlled environments, such as manufacturing plants, and standard programming can be adequate to preparing these machines to perform specific tasks in such environments. Other machines and devices, however, operate in highly variable and potentially chaotic circumstances that can present new situations that have never before been encountered by the machine or device. For example, an autonomous or semi-autonomous vehicle or other robots operating in real-world situations are expected to encounter vastly greater variation in their circumstances than will, for example, a manufacturing robot in a factory.

Machines and devices that are to be used in real-world circumstances often employ artificial intelligence/machine learning techniques to enhance their capabilities. For example, an autonomous or semi-autonomous vehicle, or other devices that use sensors to understand their situations, can use machine learning to better recognize objects in new surroundings. Such techniques may involve “teaching” a machine learning model to understand and make predictions regarding its surroundings. The teaching may be accomplished by, for example, “showing” the model a very large number (e.g., thousands or many millions) of images depicting different circumstances so the model can make sense of circumstances not before encountered. However, imaging data that captures such vastly large number of different potential circumstances (e.g., different types and sizes of streets, obstacles, vehicles, people, and pets in varying orientations) is often not readily available.

Synthetic data (e.g., artificial data intended to mimic real-world data) are valuable for training/updating machine learning models when desired quantities of actual data are unavailable. Synthetic imaging data (e.g., of different potential environments that could be encountered) can include labels that identify objects and their locations in images. But the usefulness of such synthetic data depends on its quality, and mismatches between synthetic and real-world datasets presents learning challenges in real-world applications.

Prior approaches to addressing such mismatch included (1) modifying loss functions (e.g., metrics that are used to evaluate how far an estimated or predicted value is from a “true” or actual value) and model architectures (e.g., the designs of model), or (2) translating images from synthetic to the real-world domain (e.g., making changes to synthetic data to enhance the realism of the synthetic data). Modifying loss functions and model architectures is very application- and setting-specific. Usually, the success in an application under a certain setting does not transfer well to others. Also, translating images from the synthetic domain to the real-world domain does not consider the resulting labeling mismatch between synthetic and real-world datasets; for example, if a synthetic image is enhanced to be more realistic, the labels applicable to the synthetic version of the image will often require adjustments as well, such as changes to the shape or dimensions of an object (e.g., if it is determined that an object is actually smaller than it previously appeared) or what the object is (e.g., a change from “tree” to “pedestrian” or vice-versa).

In various embodiments, the disclosed solution directly changes synthetic labels based on the raw images and metadata (e.g., data that provides information on other data) in the simulator, such as bounding region (e.g., bounding box) or depth information of an object of interest in the raw images. Given a synthetic dataset and a real-world dataset, the labels in the synthetic dataset can be translated to approach the labeling mechanism in the real-world dataset.

In various embodiments, this can be accomplished by employing a generative adversarial network (GAN)-based approach, such as an unpaired image-to-image translation model. An adversarial approach employs two models (e.g., two neural networks), a “generator” model that produces new or changed data, and a “discriminator” model that helps update/train the generator model by evaluating the new or changed data. The role of the discriminator is to “discriminate” or distinguish between real and synthetic data (e.g., decide whether an image is real or the image is synthetic). The generator seeks to “fool” the discriminator, and if the discriminator is sufficiently “fooled” (e.g., if the generator is providing synthetic data that the discriminator is not able to tell apart from real data), then the data from the generator can be deemed to be sufficiently realistic.

In various embodiments, instead of images being translated, the labels are translated. The translation can be based on the images and the metadata. Once the model is updated/trained, the model is applied to synthetic labels to obtain modified labels that are similar to real-world labels. The synthetic labels are replaced with modified labels and sim-to-real learning is performed. As opposed to approaches that modify model architectures, the disclosed approach modifies the data itself, instead of the model. And as opposed to approaches that translate images from the synthetic domain to the real-world domain, the disclosed approach translates labels instead of images. In various embodiments, a GAN model may be used to translate the labels in the source domain (e.g., synthetic data) to minimize the joint distribution between source and target datasets (e.g., real-world data).

Moreover, the performance of an image object detector strongly relies on the size of the labeled dataset. Combining different sources of datasets is a common strategy to enlarge the training dataset. However, datasets are often labeled differently, causing systematic label mismatches between datasets. Various embodiments provide an unsupervised label translator that fixes or otherwise reduces the systematic mismatches between datasets from different sources from a data-centric perspective. For example, annotating bounding boxes are ambiguous when objects are occluded, truncated, and crowded, and the approaches to handling the ambiguity can vary between datasets. For example, in some datasets but not in others, crowding objects may be allowed to be grouped into a single bounding box in certain datasets but not in others. In various embodiments, the label translation is formulated as a generative adversarial network (GAN) that functions as a label translator that consistently improves the downstream model.

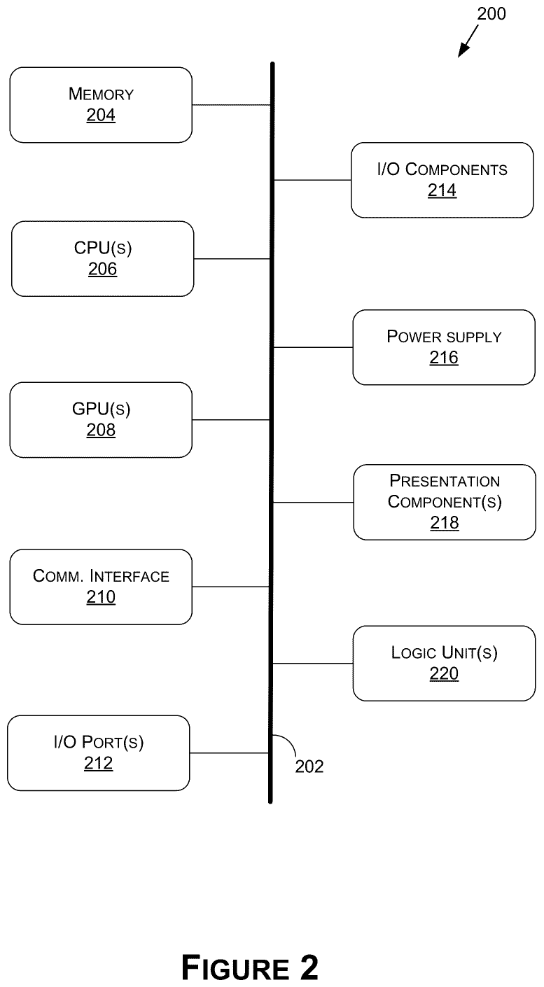

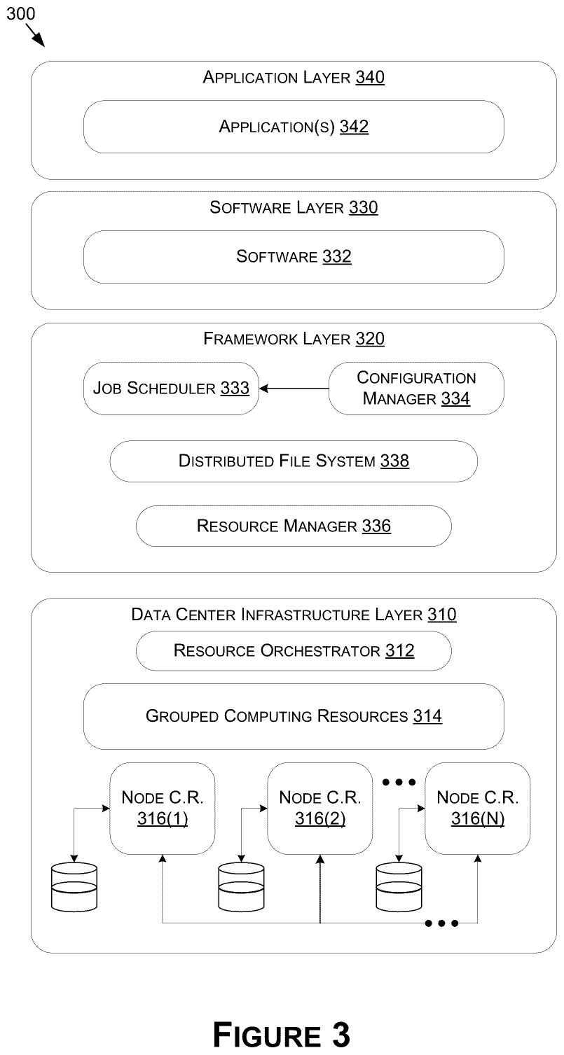

With reference to FIG. 1 (i.e., FIGS. 1A-1D), FIG. 1 is an example label translator, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 100 of FIGS. 1A-1D, example computing device 200 of FIG. 2, and/or example data center 300 of FIG. 3.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for hosting real-time streaming applications, systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

### Example Autonomous Vehicle

FIG. 1A is an illustration of an example autonomous vehicle 100, in accordance with some embodiments of the present disclosure. The autonomous vehicle 100 (alternatively referred to herein as the “vehicle 100”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 100 may be capable of functionality in accordance with one or more of Level 3-Level 5 of the autonomous driving levels. The vehicle 100 may be capable of functionality in accordance with one or more of Level 1-Level 5 of the autonomous driving levels. For example, the vehicle 100 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 100 or other machine, such as being fully autonomous, being highly autonomous, being conditionally autonomous, being partially autonomous, providing assistive autonomy, being semi-autonomous, being primarily autonomous, or other designation.

The vehicle 100 may include components such as a chassis, a vehicle body, wheels (e.g., 2, 4, 6, 8, 18, etc.), tires, axles, and other components of a vehicle. The vehicle 100 may include a propulsion system 150, such as an internal combustion engine, hybrid electric power plant, an all-electric engine, and/or another propulsion system type. The propulsion system 150 may be connected to a drive train of the vehicle 100, which may include a transmission, to enable the propulsion of the vehicle 100. The propulsion system 150 may be controlled in response to receiving signals from the throttle/accelerator 152.

A steering system 154, which may include a steering wheel, may be used to steer the vehicle 100 (e.g., along a desired path or route) when the propulsion system 150 is operating (e.g., when the vehicle is in motion). The steering system 154 may receive signals from a steering actuator 156. The steering wheel may be optional for full automation (Level 5) functionality.

The brake sensor system 146 may be used to operate the vehicle brakes in response to receiving signals from the brake actuators 148 and/or brake sensors.

Controller(s) 136, which may include one or more system on chips (SoCs) 104 (FIG. 1C) and/or GPU(s), may provide signals (e.g., representative of commands) to one or more components and/or systems of the vehicle 100. For example, the controller(s) may send signals to operate the vehicle brakes via one or more brake actuators 148, to operate the steering system 154 via one or more steering actuators 156, to operate the propulsion system 150 via one or more throttle/accelerators 152. The controller(s) 136 may include one or more onboard (e.g., integrated) computing devices (e.g., supercomputers) that process sensor signals, and output operation commands (e.g., signals representing commands) to enable autonomous driving and/or to assist a human driver in driving the vehicle 100. The controller(s) 136 may include a first controller 136 for autonomous driving functions, a second controller 136 for functional safety functions, a third controller 136 for artificial intelligence functionality (e.g., computer vision), a fourth controller 136 for infotainment functionality, a fifth controller 136 for redundancy in emergency conditions, and/or other controllers. In some examples, a single controller 136 may handle two or more of the above functionalities, two or more controllers 136 may handle a single functionality, and/or any combination thereof.

The controller(s) 136 may provide the signals for controlling one or more components and/or systems of the vehicle 100 in response to sensor data received from one or more sensors (e.g., sensor inputs). The sensor data may be received from, for example and without limitation, global navigation satellite systems (“GNSS”) sensor(s) 158 (e.g., Global Positioning System sensor(s)), RADAR sensor(s) 160, ultrasonic sensor(s) 162, LIDAR sensor(s) 164, inertial measurement unit (IMU) sensor(s) 166 (e.g., accelerometer(s), gyroscope(s), magnetic compass(es), magnetometer(s), etc.), microphone(s) 196, stereo camera(s) 168, wide-view camera(s) 170 (e.g., fisheye cameras), infrared camera(s) 172, surround camera(s) 174 (e.g., 360 degree cameras), long-range and/or mid-range camera(s) 198, speed sensor(s) 144 (e.g., for measuring the speed of the vehicle 100), vibration sensor(s) 142, steering sensor(s) 140, brake sensor(s) (e.g., as part of the brake sensor system 146), and/or other sensor types.

One or more of the controller(s) 136 may receive inputs (e.g., represented by input data) from an instrument cluster 132 of the vehicle 100 and provide outputs (e.g., represented by output data, display data, etc.) via a human-machine interface (HMI) display 134, an audible annunciator, a loudspeaker, and/or via other components of the vehicle 100. The outputs may include information such as vehicle velocity, speed, time, map data (e.g., the High Definition (“HD”) map 122 of FIG. 1C), location data (e.g., the vehicle's 100 location, such as on a map), direction, location of other vehicles (e.g., an occupancy grid), information about objects and status of objects as perceived by the controller(s) 136, etc. For example, the HMI display 134 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 100 further includes a network interface 124 which may use one or more wireless antenna(s) 126 and/or modem(s) to communicate over one or more networks. For example, the network interface 124 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 126 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 1B is an example of camera locations and fields of view for the example autonomous vehicle 100 of FIG. 1A, in accordance with some embodiments of the present disclosure. The cameras and respective fields of view are one example embodiment and are not intended to be limiting. For example, additional and/or alternative cameras may be included and/or the cameras may be located at different locations on the vehicle 100.

The camera types for the cameras may include, but are not limited to, digital cameras that may be adapted for use with the components and/or systems of the vehicle 100. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 100 (e.g., front-facing cameras) may be used for surround view, to help identify forward facing paths and obstacles, as well aid in, with the help of one or more controllers 136 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 170 that may be used to perceive objects coming into view from the periphery (e.g., pedestrians, crossing traffic or bicycles). Although only one wide-view camera is illustrated in FIG. 1B, there may be any number (including zero) of wide-view cameras 170 on the vehicle 100. In addition, any number of long-range camera(s) 198 (e.g., a long-view stereo camera pair) may be used for depth-based object detection, especially for objects for which a neural network has not yet been trained/updated. The long-range camera(s) 198 may also be used for object detection and classification, as well as basic object tracking.

Any number of stereo cameras 168 may also be included in a front-facing configuration. In at least one embodiment, one or more of stereo camera(s) 168 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 168 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 168 may be used in addition to, or alternatively from, those described herein.

Cameras with a field of view that include portions of the environment to the side of the vehicle 100 (e.g., side-view cameras) may be used for surround view, providing information used to create and update the occupancy grid, as well as to generate side impact collision warnings. For example, surround camera(s) 174 (e.g., four surround cameras 174 as illustrated in FIG. 1B) may be positioned to on the vehicle 100. The surround camera(s) 174 may include wide-view camera(s) 170, fisheye camera(s), 360 degree camera(s), and/or the like. Four example, four fisheye cameras may be positioned on the vehicle's front, rear, and sides. In an alternative arrangement, the vehicle may use three surround camera(s) 174 (e.g., left, right, and rear), and may leverage one or more other camera(s) (e.g., a forward-facing camera) as a fourth surround view camera.

Cameras with a field of view that include portions of the environment to the rear of the vehicle 100 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 198, stereo camera(s) 168), infrared camera(s) 172, etc.), as described herein.

FIG. 1C is a block diagram of an example system architecture for the example autonomous vehicle 100 of FIG. 1A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 100 in FIG. 1C are illustrated as being connected via bus 102. The bus 102 may include a Controller Area Network (CAN) data interface (alternatively referred to herein as a “CAN bus”). A CAN may be a network inside the vehicle 100 used to aid in control of various features and functionality of the vehicle 100, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 102 is described herein as being a CAN bus, this is not intended to be limiting. For example, in addition to, or alternatively from, the CAN bus, FlexRay and/or Ethernet may be used. Additionally, although a single line is used to represent the bus 102, this is not intended to be limiting. For example, there may be any number of busses 102, which may include one or more CAN busses, one or more FlexRay busses, one or more Ethernet busses, and/or one or more other types of busses using a different protocol. In some examples, two or more busses 102 may be used to perform different functions, and/or may be used for redundancy. For example, a first bus 102 may be used for collision avoidance functionality and a second bus 102 may be used for actuation control. In any example, each bus 102 may communicate with any of the components of the vehicle 100, and two or more busses 102 may communicate with the same components. In some examples, each SoC 104, each controller 136, and/or each computer within the vehicle may have access to the same input data (e.g., inputs from sensors of the vehicle 100), and may be connected to a common bus, such the CAN bus.

The vehicle 100 may include one or more controller(s) 136, such as those described herein with respect to FIG. 1A. The controller(s) 136 may be used for a variety of functions. The controller(s) 136 may be coupled to any of the various other components and systems of the vehicle 100, and may be used for control of the vehicle 100, artificial intelligence of the vehicle 100, infotainment for the vehicle 100, and/or the like.

The vehicle 100 may include a system(s) on a chip (SoC) 104. The SoC 104 may include CPU(s) 106, GPU(s) 108, processor(s) 110, cache(s) 112, accelerator(s) 114, data store(s) 116, and/or other components and features not illustrated. The SoC(s) 104 may be used to control the vehicle 100 in a variety of platforms and systems. For example, the SoC(s) 104 may be combined in a system (e.g., the system of the vehicle 100) with an HD map 122 which may obtain map refreshes and/or updates via a network interface 124 from one or more servers (e.g., server(s) 178 of FIG. 1D).

The CPU(s) 106 may include a CPU cluster or CPU complex (alternatively referred to herein as a “CCPLEX”). The CPU(s) 106 may include multiple cores and/or L2 caches. For example, in some embodiments, the CPU(s) 106 may include eight cores in a coherent multi-processor configuration. In some embodiments, the CPU(s) 106 may include four dual-core clusters where each cluster has a dedicated L2 cache (e.g., a 2 MB L2 cache). The CPU(s) 106 (e.g., the CCPLEX) may be configured to support simultaneous cluster operation enabling any combination of the clusters of the CPU(s) 106 to be active at any given time.

The CPU(s) 106 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 106 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 108 may include an integrated GPU (alternatively referred to herein as an “iGPU”). The GPU(s) 108 may be programmable and may be efficient for parallel workloads. The GPU(s) 108, in some examples, may use an enhanced tensor instruction set. The GPU(s) 108 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 108 may include at least eight streaming microprocessors. The GPU(s) 108 may use compute application programming interface(s) (API(s)). In addition, the GPU(s) 108 may use one or more parallel computing platforms and/or programming models (e.g., NVIDIA's CUDA).

The GPU(s) 108 may be power-optimized for best performance in automotive and embedded use cases. For example, the GPU(s) 108 may be fabricated on a Fin field-effect transistor (FinFET). However, this is not intended to be limiting and the GPU(s) 108 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 108 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 108 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 108 to access the CPU(s) 106 page tables directly. In such examples, when the GPU(s) 108 memory management unit (MMU) experiences a miss, an address translation request may be transmitted to the CPU(s) 106. In response, the CPU(s) 106 may look in its page tables for the virtual-to-physical mapping for the address and transmits the translation back to the GPU(s) 108. As such, unified memory technology may allow a single unified virtual address space for memory of both the CPU(s) 106 and the GPU(s) 108, thereby simplifying the GPU(s) 108 programming and porting of applications to the GPU(s) 108.

In addition, the GPU(s) 108 may include an access counter that may keep track of the frequency of access of the GPU(s) 108 to memory of other processors. The access counter may help ensure that memory pages are moved to the physical memory of the processor that is accessing the pages most frequently.

The SoC(s) 104 may include any number of cache(s) 112, including those described herein. For example, the cache(s) 112 may include an L3 cache that is available to both the CPU(s) 106 and the GPU(s) 108 (e.g., that is connected both the CPU(s) 106 and the GPU(s) 108). The cache(s) 112 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 104 may include an arithmetic logic unit(s) (ALU(s)) which may be leveraged in performing processing with respect to any of the variety of tasks or operations of the vehicle 100—such as processing DNNs. In addition, the SoC(s) 104 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 106 and/or GPU(s) 108.

The SoC(s) 104 may include one or more accelerators 114 (e.g., hardware accelerators, software accelerators, or a combination thereof). For example, the SoC(s) 104 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 108 and to off-load some of the tasks of the GPU(s) 108 (e.g., to free up more cycles of the GPU(s) 108 for performing other tasks). As an example, the accelerator(s) 114 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 114 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 108, and by using an inference accelerator, for example, a designer may target either the DLA(s) or the GPU(s) 108 for any function. For example, the designer may focus processing of CNNs and floating point operations on the DLA(s) and leave other functions to the GPU(s) 108 and/or other accelerator(s) 114.

The accelerator(s) 114 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 106. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 114 (e.g., the hardware acceleration cluster) may include a computer vision network on-chip and SRAM, for providing a high-bandwidth, low latency SRAM for the accelerator(s) 114. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 104 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 114 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 166 output that correlates with the vehicle 100 orientation, distance, 3D location estimates of the object obtained from the neural network and/or other sensors (e.g., LIDAR sensor(s) 164 or RADAR sensor(s) 160), among others.

The SoC(s) 104 may include data store(s) 116 (e.g., memory). The data store(s) 116 may be on-chip memory of the SoC(s) 104, which may store neural networks to be executed on the GPU and/or the DLA. In some examples, the data store(s) 116 may be large enough in capacity to store multiple instances of neural networks for redundancy and safety. The data store(s) 112 may comprise L2 or L3 cache(s) 112. Reference to the data store(s) 116 may include reference to the memory associated with the PVA, DLA, and/or other accelerator(s) 114, as described herein.

The SoC(s) 104 may include one or more processor(s) 110 (e.g., embedded processors). The processor(s) 110 may include a boot and power management processor that may be a dedicated processor and subsystem to handle boot power and management functions and related security enforcement. The boot and power management processor may be a part of the SoC(s) 104 boot sequence and may provide runtime power management services. The boot power and management processor may provide clock and voltage programming, assistance in system low power state transitions, management of SoC(s) 104 thermals and temperature sensors, and/or management of the SoC(s) 104 power states. Each temperature sensor may be implemented as a ring-oscillator whose output frequency is proportional to temperature, and the SoC(s) 104 may use the ring-oscillators to detect temperatures of the CPU(s) 106, GPU(s) 108, and/or accelerator(s) 114. If temperatures are determined to exceed a threshold, the boot and power management processor may enter a temperature fault routine and put the SoC(s) 104 into a lower power state and/or put the vehicle 100 into a chauffeur to safe stop mode (e.g., bring the vehicle 100 to a safe stop).

The processor(s) 110 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 110 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 110 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 110 may further include a real-time camera engine that may include a dedicated processor subsystem for handling real-time camera management.

The processor(s) 110 may further include a high-dynamic range signal processor that may include an image signal processor that is a hardware engine that is part of the camera processing pipeline.

The processor(s) 110 may include a video image compositor that may be a processing block (e.g., implemented on a microprocessor) that implements video post-processing functions needed by a video playback application to produce the final image for the player window. The video image compositor may perform lens distortion correction on wide-view camera(s) 170, surround camera(s) 174, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 108 is not required to continuously render new surfaces. Even when the GPU(s) 108 is powered on and active doing 3D rendering, the video image compositor may be used to offload the GPU(s) 108 to improve performance and responsiveness.

The SoC(s) 104 may further include a mobile industry processor interface (MIPI) camera serial interface for receiving video and input from cameras, a high-speed interface, and/or a video input block that may be used for camera and related pixel input functions. The SoC(s) 104 may further include an input/output controller(s) that may be controlled by software and may be used for receiving I/O signals that are uncommitted to a specific role.

The SoC(s) 104 may further include a broad range of peripheral interfaces to enable communication with peripherals, audio codecs, power management, and/or other devices. The SoC(s) 104 may be used to process data from cameras (e.g., connected over Gigabit Multimedia Serial Link and Ethernet), sensors (e.g., LIDAR sensor(s) 164, RADAR sensor(s) 160, etc. that may be connected over Ethernet), data from bus 102 (e.g., speed of vehicle 100, steering wheel position, etc.), data from GNSS sensor(s) 158 (e.g., connected over Ethernet or CAN bus). The SoC(s) 104 may further include dedicated high-performance mass storage controllers that may include their own DMA engines, and that may be used to free the CPU(s) 106 from routine data management tasks.

The SoC(s) 104 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 104 may be faster, more reliable, and even more energy-efficient and space-efficient than conventional systems. For example, the accelerator(s) 114, when combined with the CPU(s) 106, the GPU(s) 108, and the data store(s) 116, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 120) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 108.

In some examples, a CNN for facial recognition and vehicle owner identification may use data from camera sensors to identify the presence of an authorized driver and/or owner of the vehicle 100. The always on sensor processing engine may be used to unlock the vehicle when the owner approaches the driver door and turn on the lights, and, in security mode, to disable the vehicle when the owner leaves the vehicle. In this way, the SoC(s) 104 provide for security against theft and/or carjacking.

In another example, a CNN for emergency vehicle detection and identification may use data from microphones 196 to detect and identify emergency vehicle sirens. In contrast to conventional systems, that use general classifiers to detect sirens and manually extract features, the SoC(s) 104 use the CNN for classifying environmental and urban sounds, as well as classifying visual data. In a preferred embodiment, the CNN running on the DLA is trained/updated/configured to identify the relative closing speed of the emergency vehicle (e.g., by using the Doppler Effect). The CNN may also be trained/updated to identify emergency vehicles specific to the local area in which the vehicle is operating, as identified by GNSS sensor(s) 158. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 162, until the emergency vehicle(s) passes.

The vehicle may include a CPU(s) 118 (e.g., discrete CPU(s), or dCPU(s)), that may be coupled to the SoC(s) 104 via a high-speed interconnect (e.g., PCIe). The CPU(s) 118 may include an X86 processor, for example. The CPU(s) 118 may be used to perform any of a variety of functions, including arbitrating potentially inconsistent results between ADAS sensors and the SoC(s) 104, and/or monitoring the status and health of the controller(s) 136 and/or infotainment SoC 130, for example.

The vehicle 100 may include a GPU(s) 120 (e.g., discrete GPU(s), or dGPU(s)), that may be coupled to the SoC(s) 104 via a high-speed interconnect (e.g., NVIDIA's NVLINK). The GPU(s) 120 may provide additional artificial intelligence functionality, such as by executing redundant and/or different neural networks, and may be used to train and/or update neural networks based on input (e.g., sensor data) from sensors of the vehicle 100.

The vehicle 100 may further include the network interface 124 which may include one or more wireless antennas 126 (e.g., one or more wireless antennas for different communication protocols, such as a cellular antenna, a Bluetooth antenna, etc.). The network interface 124 may be used to enable wireless connectivity over the Internet with the cloud (e.g., with the server(s) 178 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 100 information about vehicles in proximity to the vehicle 100 (e.g., vehicles in front of, on the side of, and/or behind the vehicle 100). This functionality may be part of a cooperative adaptive cruise control functionality of the vehicle 100.

The network interface 124 may include a SoC that provides modulation and demodulation functionality and enables the controller(s) 136 to communicate over wireless networks. The network interface 124 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 100 may further include data store(s) 128 which may include off-chip (e.g., off the SoC(s) 104) storage. The data store(s) 128 may include one or more storage elements including RAM, SRAM, DRAM, VRAM, Flash, hard disks, and/or other components and/or devices that may store at least one bit of data.

The vehicle 100 may further include GNSS sensor(s) 158. The GNSS sensor(s) 158 (e.g., GPS, assisted GPS sensors, differential GPS (DGPS) sensors, etc.), to assist in mapping, perception, occupancy grid generation, and/or path planning functions. Any number of GNSS sensor(s) 158 may be used, including, for example and without limitation, a GPS using a USB connector with an Ethernet to Serial (RS-232) bridge.

The vehicle 100 may further include RADAR sensor(s) 160. The RADAR sensor(s) 160 may be used by the vehicle 100 for long-range vehicle detection, even in darkness and/or severe weather conditions. RADAR functional safety levels may be ASIL B. The RADAR sensor(s) 160 may use the CAN and/or the bus 102 (e.g., to transmit data generated by the RADAR sensor(s) 160) for control and to access object tracking data, with access to Ethernet to access raw data in some examples. A wide variety of RADAR sensor types may be used. For example, and without limitation, the RADAR sensor(s) 160 may be suitable for front, rear, and side RADAR use. In some example, Pulse Doppler RADAR sensor(s) are used.

The RADAR sensor(s) 160 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 160 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 100 surroundings at higher speeds with minimal interference from traffic in adjacent lanes. The other two antennae may expand the field of view, making it possible to quickly detect vehicles entering or leaving the vehicle's 100 lane.

Mid-range RADAR systems may include, as an example, a range of up to 160 m (front) or 80 m (rear), and a field of view of up to 42 degrees (front) or 150 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 100 may further include ultrasonic sensor(s) 162. The ultrasonic sensor(s) 162, which may be positioned at the front, back, and/or the sides of the vehicle 100, may be used for park assist and/or to create and update an occupancy grid. A wide variety of ultrasonic sensor(s) 162 may be used, and different ultrasonic sensor(s) 162 may be used for different ranges of detection (e.g., 2.5 m, 4 m). The ultrasonic sensor(s) 162 may operate at functional safety levels of ASIL B.

The vehicle 100 may include LIDAR sensor(s) 164. The LIDAR sensor(s) 164 may be used for object and pedestrian detection, emergency braking, collision avoidance, and/or other functions. The LIDAR sensor(s) 164 may be functional safety level ASIL B. In some examples, the vehicle 100 may include multiple LIDAR sensors 164 (e.g., two, four, six, etc.) that may use Ethernet (e.g., to provide data to a Gigabit Ethernet switch).

In some examples, the LIDAR sensor(s) 164 may be capable of providing a list of objects and their distances for a 360-degree field of view. Commercially available LIDAR sensor(s) 164 may have an advertised range of approximately 100 m, with an accuracy of 2 cm-3 cm, and with support for a 100 Mbps Ethernet connection, for example. In some examples, one or more non-protruding LIDAR sensors 164 may be used. In such examples, the LIDAR sensor(s) 164 may be implemented as a small device that may be embedded into the front, rear, sides, and/or corners of the vehicle 100. The LIDAR sensor(s) 164, in such examples, may provide up to a 120-degree horizontal and 35-degree vertical field-of-view, with a 200 m range even for low-reflectivity objects. Front-mounted LIDAR sensor(s) 164 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 100. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 164 may be less susceptible to motion blur, vibration, and/or shock.

The vehicle may further include IMU sensor(s) 166. The IMU sensor(s) 166 may be located at a center of the rear axle of the vehicle 100, in some examples. The IMU sensor(s) 166 may include, for example and without limitation, an accelerometer(s), a magnetometer(s), a gyroscope(s), a magnetic compass(es), and/or other sensor types. In some examples, such as in six-axis applications, the IMU sensor(s) 166 may include accelerometers and gyroscopes, while in nine-axis applications, the IMU sensor(s) 166 may include accelerometers, gyroscopes, and magnetometers.

In some embodiments, the IMU sensor(s) 166 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 166 may enable the vehicle 100 to estimate heading without requiring input from a magnetic sensor by directly observing and correlating the changes in velocity from GPS to the IMU sensor(s) 166. In some examples, the IMU sensor(s) 166 and the GNSS sensor(s) 158 may be combined in a single integrated unit.

The vehicle may include microphone(s) 196 placed in and/or around the vehicle 100. The microphone(s) 196 may be used for emergency vehicle detection and identification, among other things.

The vehicle may further include any number of camera types, including stereo camera(s) 168, wide-view camera(s) 170, infrared camera(s) 172, surround camera(s) 174, long-range and/or mid-range camera(s) 198, and/or other camera types. The cameras may be used to capture image data around an entire periphery of the vehicle 100. The types of cameras used depends on the embodiments and requirements for the vehicle 100, and any combination of camera types may be used to provide the necessary coverage around the vehicle 100. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 1A and FIG. 1B.

The vehicle 100 may further include vibration sensor(s) 142. The vibration sensor(s) 142 may measure vibrations of components of the vehicle, such as the axle(s). For example, changes in vibrations may indicate a change in road surfaces. In another example, when two or more vibration sensors 142 are used, the differences between the vibrations may be used to determine friction or slippage of the road surface (e.g., when the difference in vibration is between a power-driven axle and a freely rotating axle).

The vehicle 100 may include an ADAS system 138. The ADAS system 138 may include a SoC, in some examples. The ADAS system 138 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 160, LIDAR sensor(s) 164, and/or a camera(s). The ACC systems may include longitudinal ACC and/or lateral ACC. Longitudinal ACC monitors and controls the distance to the vehicle immediately ahead of the vehicle 100 and automatically adjust the vehicle speed to maintain a safe distance from vehicles ahead. Lateral ACC performs distance keeping, and advises the vehicle 100 to change lanes when necessary. Lateral ACC is related to other ADAS applications such as LCA and CWS.

CACC uses information from other vehicles that may be received via the network interface 124 and/or the wireless antenna(s) 126 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 100), while the I2V communication concept provides information about traffic further ahead. CACC systems may include either or both I2V and V2V information sources. Given the information of the vehicles ahead of the vehicle 100, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 160, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 160, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 100 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 100 if the vehicle 100 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 160, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 100 is backing up. Some RCTW systems include AEB to ensure that the vehicle brakes are applied to avoid a crash. RCTW systems may use one or more rear-facing RADAR sensor(s) 160, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 100, the vehicle 100 itself must, in the case of conflicting results, decide whether to heed the result from a primary computer or a secondary computer (e.g., a first controller 136 or a second controller 136). For example, in some embodiments, the ADAS system 138 may be a backup and/or secondary computer for providing perception information to a backup computer rationality module. The backup computer rationality monitor may run a redundant diverse software on hardware components to detect faults in perception and dynamic driving tasks. Outputs from the ADAS system 138 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and/or configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 104.

In other examples, ADAS system 138 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 138 may be fed into the primary computer's perception block and/or the primary computer's dynamic driving task block. For example, if the ADAS system 138 indicates a forward crash warning due to an object immediately ahead, the perception block may use this information when identifying objects. In other examples, the secondary computer may have its own neural network which is trained and thus reduces the risk of false positives, as described herein.

The vehicle 100 may further include the infotainment SoC 130 (e.g., an in-vehicle infotainment system (IVI)). Although illustrated and described as a SoC, the infotainment system may not be a SoC, and may include two or more discrete components. The infotainment SoC 130 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 100. For example, the infotainment SoC 130 may radios, disk players, navigation systems, video players, USB and Bluetooth connectivity, carputers, in-car entertainment, Wi-Fi, steering wheel audio controls, hands free voice control, a heads-up display (HUD), an HMI display 134, a telematics device, a control panel (e.g., for controlling and/or interacting with various components, features, and/or systems), and/or other components. The infotainment SoC 130 may further be used to provide information (e.g., visual and/or audible) to a user(s) of the vehicle, such as information from the ADAS system 138, autonomous driving information such as planned vehicle maneuvers, trajectories, surrounding environment information (e.g., intersection information, vehicle information, road information, etc.), and/or other information.

The infotainment SoC 130 may include GPU functionality. The infotainment SoC 130 may communicate over the bus 102 (e.g., CAN bus, Ethernet, etc.) with other devices, systems, and/or components of the vehicle 100. In some examples, the infotainment SoC 130 may be coupled to a supervisory MCU such that the GPU of the infotainment system may perform some self-driving functions in the event that the primary controller(s) 136 (e.g., the primary and/or backup computers of the vehicle 100) fail. In such an example, the infotainment SoC 130 may put the vehicle 100 into a chauffeur to safe stop mode, as described herein.

The vehicle 100 may further include an instrument cluster 132 (e.g., a digital dash, an electronic instrument cluster, a digital instrument panel, etc.). The instrument cluster 132 may include a controller and/or supercomputer (e.g., a discrete controller or supercomputer). The instrument cluster 132 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 130 and the instrument cluster 132. In other words, the instrument cluster 132 may be included as part of the infotainment SoC 130, or vice versa.

FIG. 1D is a system diagram for communication between cloud-based server(s) and the example autonomous vehicle 100 of FIG. 1A, in accordance with some embodiments of the present disclosure. The system 176 may include server(s) 178, network(s) 190, and vehicles, including the vehicle 100. The server(s) 178 may include a plurality of GPUs 184(A)-184(H) (collectively referred to herein as GPUs 184), PCIe switches 182(A)-182(H) (collectively referred to herein as PCIe switches 182), and/or CPUs 180(A)-180(B) (collectively referred to herein as CPUs 180). The GPUs 184, the CPUs 180, and the PCIe switches may be interconnected with high-speed interconnects such as, for example and without limitation, NVLink interfaces 188 developed by NVIDIA and/or PCIe connections 186. In some examples, the GPUs 184 are connected via NVLink and/or NVSwitch SoC and the GPUs 184 and the PCIe switches 182 are connected via PCIe interconnects. Although eight GPUs 184, two CPUs 180, and two PCIe switches are illustrated, this is not intended to be limiting. Depending on the embodiment, each of the server(s) 178 may include any number of GPUs 184, CPUs 180, and/or PCIe switches. For example, the server(s) 178 may each include eight, sixteen, thirty-two, and/or more GPUs 184.

The server(s) 178 may receive, over the network(s) 190 and from the vehicles, image data representative of images showing unexpected or changed road conditions, such as recently commenced road-work. The server(s) 178 may transmit, over the network(s) 190 and to the vehicles, neural networks 192, updated neural networks 192, and/or map information 194, including information regarding traffic and road conditions. The updates to the map information 194 may include updates for the HD map 122, such as information regarding construction sites, potholes, detours, flooding, and/or other obstructions. In some examples, the neural networks 192, the updated neural networks 192, and/or the map information 194 may have resulted from new training and/or experiences represented in data received from any number of vehicles in the environment, and/or based on training performed at a datacenter (e.g., using the server(s) 178 and/or other servers).

The server(s) 178 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 190, and/or the machine learning models may be used by the server(s) 178 to remotely monitor the vehicles.

In some examples, the server(s) 178 may receive data from the vehicles and apply the data to up-to-date real-time neural networks for real-time intelligent inferencing. The server(s) 178 may include deep-learning supercomputers and/or dedicated AI computers powered by GPU(s) 184, such as a DGX and DGX Station machines developed by NVIDIA. However, in some examples, the server(s) 178 may include deep learning infrastructure that use only CPU-powered datacenters.

The deep-learning infrastructure of the server(s) 178 may be capable of fast, real-time inferencing, and may use that capability to evaluate and verify the health of the processors, software, and/or associated hardware in the vehicle 100. For example, the deep-learning infrastructure may receive periodic updates from the vehicle 100, such as a sequence of images and/or objects that the vehicle 100 has located in that sequence of images (e.g., via computer vision and/or other machine learning object classification techniques). The deep-learning infrastructure may run its own neural network to identify the objects and compare them with the objects identified by the vehicle 100 and, if the results do not match and the infrastructure concludes that the AI in the vehicle 100 is malfunctioning, the server(s) 178 may transmit a signal to the vehicle 100 instructing a fail-safe computer of the vehicle 100 to assume control, notify the passengers, and complete a safe parking maneuver.

For inferencing, the server(s) 178 may include the GPU(s) 184 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 2 is a block diagram of an example computing device(s) 200 suitable for use in implementing some embodiments of the present disclosure. Computing device 200 may include an interconnect system 202 that directly or indirectly couples the following devices: memory 204, one or more central processing units (CPUs) 206, one or more graphics processing units (GPUs) 208, a communication interface 210, input/output (I/O) ports 212, input/output components 214, a power supply 216, one or more presentation components 218 (e.g., display(s)), and one or more logic units 220. In at least one embodiment, the computing device(s) 200 may comprise one or more virtual machines (VMs), and/or any of the components thereof may comprise virtual components (e.g., virtual hardware components). For non-limiting examples, one or more of the GPUs 208 may comprise one or more vGPUs, one or more of the CPUs 206 may comprise one or more vCPUs, and/or one or more of the logic units 220 may comprise one or more virtual logic units. As such, a computing device(s) 200 may include discrete components (e.g., a full GPU dedicated to the computing device 200), virtual components (e.g., a portion of a GPU dedicated to the computing device 200), or a combination thereof.

Although the various blocks of FIG. 2 are shown as connected via the interconnect system 202 with lines, this is not intended to be limiting and is for clarity only. For example, in some embodiments, a presentation component 218, such as a display device, may be considered an I/O component 214 (e.g., if the display is a touch screen). As another example, the CPUs 206 and/or GPUs 208 may include memory (e.g., the memory 204 may be representative of a storage device in addition to the memory of the GPUs 208, the CPUs 206, and/or other components). In other words, the computing device of FIG. 2 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 2.

The interconnect system 202 may represent one or more links or busses, such as an address bus, a data bus, a control bus, or a combination thereof. The interconnect system 202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 206 may be directly connected to the memory 204. Further, the CPU 206 may be directly connected to the GPU 208. Where there is direct, or point-to-point connection between components, the interconnect system 202 may include a PCIe link to carry out the connection. In these examples, a PCI bus need not be included in the computing device 200.

The memory 204 may include any of a variety of computer-readable media. The computer-readable media may be any available media that may be accessed by the computing device 200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 206 may be configured to execute at least some of the computer-readable instructions to control one or more components of the computing device 200 to perform one or more of the methods and/or processes described herein. The CPU(s) 206 may each include one or more cores (e.g., one, two, four, eight, twenty-eight, seventy-two, etc.) that are capable of handling a multitude of software threads simultaneously. The CPU(s) 206 may include any type of processor, and may include different types of processors depending on the type of computing device 200 implemented (e.g., processors with fewer cores for mobile devices and processors with more cores for servers). For example, depending on the type of computing device 200, the processor may be an Advanced RISC Machines (ARM) processor implemented using Reduced Instruction Set Computing (RISC) or an x86 processor implemented using Complex Instruction Set Computing (CISC). The computing device 200 may include one or more CPUs 206 in addition to one or more microprocessors or supplementary co-processors, such as math co-processors.

In addition to or alternatively from the CPU(s) 206, the GPU(s) 208 may be configured to execute at least some of the computer-readable instructions to control one or more components of the computing device 200 to perform one or more of the methods and/or processes described herein. One or more of the GPU(s) 208 may be an integrated GPU (e.g., with one or more of the CPU(s) 206 and/or one or more of the GPU(s) 208 may be a discrete GPU. In embodiments, one or more of the GPU(s) 208 may be a coprocessor of one or more of the CPU(s) 206. The GPU(s) 208 may be used by the computing device 200 to render graphics (e.g., 3D graphics) or perform general purpose computations. For example, the GPU(s) 208 may be used for General-Purpose computing on GPUs (GPGPU). The GPU(s) 208 may include hundreds or thousands of cores that are capable of handling hundreds or thousands of software threads simultaneously. The GPU(s) 208 may generate pixel data for output images in response to rendering commands (e.g., rendering commands from the CPU(s) 206 received via a host interface). The GPU(s) 208 may include graphics memory, such as display memory, for storing pixel data or any other suitable data, such as GPGPU data. The display memory may be included as part of the memory 204. The GPU(s) 208 may include two or more GPUs operating in parallel (e.g., via a link). The link may directly connect the GPUs (e.g., using NVLINK) or may connect the GPUs through a switch (e.g., using NVSwitch). When combined together, each GPU 208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 206 and/or the GPU(s) 208, the logic unit(s) 220 may be configured to execute at least some of the computer-readable instructions to control one or more components of the computing device 200 to perform one or more of the methods and/or processes described herein. In embodiments, the CPU(s) 206, the GPU(s) 208, and/or the logic unit(s) 220 may discretely or jointly perform any combination of the methods, processes and/or portions thereof. One or more of the logic units 220 may be part of and/or integrated in one or more of the CPU(s) 206 and/or the GPU(s) 208 and/or one or more of the logic units 220 may be discrete components or otherwise external to the CPU(s) 206 and/or the GPU(s) 208. In embodiments, one or more of the logic units 220 may be a coprocessor of one or more of the CPU(s) 206 and/or one or more of the GPU(s) 208.

Examples of the logic unit(s) 220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 210 may include one or more receivers, transmitters, and/or transceivers that enable the computing device 200 to communicate with other computing devices via an electronic communication network, included wired and/or wireless communications. The communication interface 210 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 220 and/or communication interface 210 may include one or more data processing units (DPUs) to transmit data received over a network and/or through interconnect system 202 directly to (e.g., a memory of) one or more GPU(s) 208.

The I/O ports 212 may enable the computing device 200 to be logically coupled to other devices including the I/O components 214, the presentation component(s) 218, and/or other components, some of which may be built in to (e.g., integrated in) the computing device 200. Illustrative I/O components 214 include a microphone, mouse, keyboard, joystick, game pad, game controller, satellite dish, scanner, printer, wireless device, etc. The I/O components 214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 200. The computing device 200 may be include depth cameras, such as stereoscopic camera systems, infrared camera systems, RGB camera systems, touchscreen technology, and combinations of these, for gesture detection and recognition. Additionally, the computing device 200 may include accelerometers or gyroscopes (e.g., as part of an inertia measurement unit (IMU)) that enable detection of motion. In some examples, the output of the accelerometers or gyroscopes may be used by the computing device 200 to render immersive augmented reality or virtual reality.

The power supply 216 may include a hard-wired power supply, a battery power supply, or a combination thereof. The power supply 216 may provide power to the computing device 200 to enable the components of the computing device 200 to operate.

The presentation component(s) 218 may include a display (e.g., a monitor, a touch screen, a television screen, a heads-up-display (HUD), other display types, or a combination thereof), speakers, and/or other presentation components. The presentation component(s) 218 may receive data from other components (e.g., the GPU(s) 208, the CPU(s) 206, DPUs, etc.), and output the data (e.g., as an image, video, sound, etc.).

### Example Data Center

FIG. 3 illustrates an example data center 300 that may be used in at least one embodiments of the present disclosure. The data center 300 may include a data center infrastructure layer 310, a framework layer 320, a software layer 330, and/or an application layer 330.

As shown in FIG. 3, the data center infrastructure layer 310 may include a resource orchestrator 312, grouped computing resources 314, and node computing resources (“node C.R.s”) 316(1)-316(N), where “N” represents any whole, positive integer. In at least one embodiment, node C.R.s 316(1)-316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 316(1)-316(N) may correspond to a server having one or more of the above-mentioned computing resources. In addition, in some embodiments, the node C.R.s 316(1)-316(N) may include one or more virtual components, such as vGPUs, vCPUs, and/or the like, and/or one or more of the node C.R.s 316(1)-316(N) may correspond to a virtual machine (VM).

In at least one embodiment, grouped computing resources 314 may include separate groupings of node C.R.s 316 housed within one or more racks (not shown), or many racks housed in data centers at various geographical locations (also not shown). Separate groupings of node C.R.s 316 within grouped computing resources 314 may include grouped compute, network, memory or storage resources that may be configured or allocated to support one or more workloads. In at least one embodiment, several node C.R.s 316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 312 may configure or otherwise control one or more node C.R.s 316(1)-316(N) and/or grouped computing resources 314. In at least one embodiment, resource orchestrator 312 may include a software design infrastructure (SDI) management entity for the data center 300. The resource orchestrator 312 may include hardware, software, or some combination thereof.

In at least one embodiment, as shown in FIG. 3, framework layer 320 may include a job scheduler 333, a configuration manager 334, a resource manager 336, and/or a distributed file system 338. The framework layer 320 may include a framework to support software 332 of software layer 330 and/or one or more application(s) 342 of application layer 340. The software 332 or application(s) 342 may respectively include web-based service software or applications, such as those provided by Amazon Web Services, Google Cloud and Microsoft Azure. The framework layer 320 may be, but is not limited to, a type of free and open-source software web application framework such as Apache Spark™ (hereinafter “Spark”) that may utilize distributed file system 338 for large-scale data processing (e.g., “big data”). In at least one embodiment, job scheduler 333 may include a Spark driver to facilitate scheduling of workloads supported by various layers of data center 300. The configuration manager 334 may be capable of configuring different layers such as software layer 330 and framework layer 320 including Spark and distributed file system 338 for supporting large-scale data processing. The resource manager 336 may be capable of managing clustered or grouped computing resources mapped to or allocated for support of distributed file system 338 and job scheduler 333. In at least one embodiment, clustered or grouped computing resources may include grouped computing resource 314 at data center infrastructure layer 310. The resource manager 336 may coordinate with resource orchestrator 312 to manage these mapped or allocated computing resources.

In at least one embodiment, software 332 included in software layer 330 may include software used by at least portions of node C.R.s 316(1)-316(N), grouped computing resources 314, and/or distributed file system 338 of framework layer 320. One or more types of software may include, but are not limited to, Internet web page search software, e-mail virus scan software, database software, and streaming video content software.

In at least one embodiment, application(s) 342 included in application layer 340 may include one or more types of applications used by at least portions of node C.R.s 316(1)-316(N), grouped computing resources 314, and/or distributed file system 338 of framework layer 320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 334, resource manager 336, and resource orchestrator 312 may implement any number and type of self-modifying actions based on any amount and type of data acquired in any technically feasible fashion. Self-modifying actions may relieve a data center operator of data center 300 from making possibly bad configuration decisions and possibly avoiding underutilized and/or poor performing portions of a data center.

The data center 300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 300. In at least one embodiment, trained or deployed machine learning models corresponding to one or more neural networks may be used to infer or predict information using resources described above with respect to the data center 300 by using weight parameters calculated through one or more training techniques, such as but not limited to those described herein.

In at least one embodiment, the data center 300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 200 of FIG. 2—e.g., each device may include similar components, features, and/or functionality of the computing device(s) 200. In addition, where backend devices (e.g., servers, NAS, etc.) are implemented, the backend devices may be included as part of a data center 300, an example of which is described in more detail herein with respect to FIG. 3.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 200 described herein with respect to FIG. 2. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

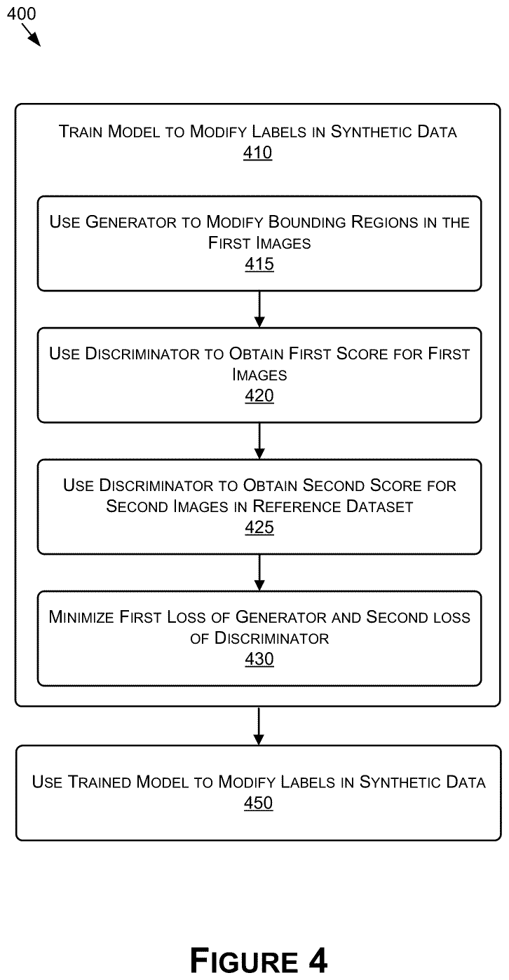

Now referring to FIG. 4, each block of method 400, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), an application programming interface (API), or a plug-in to another product, to name a few. In addition, method 400 is described, by way of example, with respect to the system architectures of FIGS. 1A to 3. However, these methods may additionally or alternatively be executed by any one system, or any combination of systems, including, but not limited to, those described herein.

FIG. 4 is a flow diagram showing a method 400 for translating labels, in accordance with some embodiments of the present disclosure. The method 400, at block 410, includes training a model, and at block 450, includes using the trained model. The model can be a GAN-based machine learning model that employs two neural networks, a generator (e.g., a data generating model, a generative model, or a generator model) and a discriminator (e.g., a data discriminating model, a discriminative model, or a discriminator model). The model can be trained to modify labels in imaging data in a source dataset. The source dataset can be, or can comprise, synthetic images with labels.

The labels can be, or can comprise (e.g., can reference/specify/indicate and/or be specific to), bounding regions that surround or otherwise define objects in images. Modifying a label can comprise, or can be, changing a shape and/or a dimension of a bounding region. The bounding region may be modified based on changes (e.g., changes in location or intensity) in pixels proximate to the bounding region. In various embodiments, this can comprise identifying pixels proximate to (e.g., adjacent to or otherwise near) the bounding regions of the first images. The identified pixels may be used to modify the bounding regions of the first images (e.g., a bounding region can be reduced/extended/changed according to proximity/difference in intensity and/or other characteristics to at least one other/reference/target pixel that may be in a previous/unmodified bounding region for instance). For example, a bounding region may be increased in size to include one or more pixels identified to have same/similar/related intensity/characteristic as a group of pixels already in the bounding region.

Training the model can comprise, at block 415, using the generator to modify bounding regions in a first set of images. The first set of images may be synthetic images in a source dataset, which can include, or can consist of, synthetic imaging data. A bounding region may be, but need not be, a rectangular box, or a more specific shape that outlines or otherwise surrounds one or more objects.

At block 420, the discriminator may generate or otherwise obtain a first score for the first set of images and the modified bounding regions. As further discussed below, this corresponds with the pseudocode D (image_A, translated_boxes_A), as further discussed below, where D corresponds with the discriminator, and the “image_A” and “translated boxes A” correspond to inputs to the discriminator.

At block 425, the discriminator may generate or otherwise obtain a second score for a second set of images. The second set of images may be “real” images in a reference dataset that can include, or can consist of, real imaging data. The second score may correspond with pseudocode D (image_B, boxes_B) as further discussed below.

At block 430, training the model comprises minimizing losses through loss functions. Block 430 can comprise minimizing a first loss of the generator. This may correspond with pseudocode minimize_G (D (image_A, translated_boxes_A)−1)**2 as further discussed below. Block 430 can further comprise minimizing a second loss of the discriminator. This may correspond with pseudocode minimize_D (D (image_B, boxes_B)−1)**2+\ (D (image_A, translated boxes_A)−0)**2+MMD (image_A, image_B) as further discussed below. Determining the second loss may employ a function to minimize differences between the first set of images and the second set of images. The function may be/include a maximum mean discrepancy (MMD) function, as represented by the pseudocode MMD (image_A, image_B) discussed below.

At block 450, the trained model may be used to modify labels in synthetic data. In various embodiments, this may comprise modifying the bounded regions in the first set of images. Additionally or alternatively, the trained model may be used to modify bounding regions in other images.

As discussed, a GAN model can be used to translate labels in the source (e.g., synthetic) domain to minimize joint distribution between source and target (e.g., real) datasets. The generator (“G”) side of the training process may comprise initializing the generator as identity translation, as represented by the pseudocode in Table 1:

TABLE 1
Generator forward, initialize G as identity translation

# Generator: translated_boxes = G(image, boxes)
Inputs: (image, boxes) from source datasets
multi_lvl_resnet_features = ResNet(image)
image_features = Transformer(multi_lvl_resnet_features)
boxes_change = Transformer(image_features,
boxes) # Deformable-Attention modules
translated_boxes = alpha *
boxes_change + boxes # alpha is initialized as zero (0)

The discriminator (“D”) may be a spectral-normal discriminator, as represented in the following pseudocode in Table 2:

TABLE 2
Discriminator forward, spectral-normal discriminator

# Discriminator:
# - real_score = D(image, boxes)
# - faka_score = D(image, translated_boxes)
# Spectral-normalized D
Inputs:
- Real pair: (image, boxes) from target datasets
- Fake pair: (image, translated_boxes) from source datasets
multi_lvl_resnet_features = ResNet(image)
image_features = Transformer(multi_lvl_resnet_features)
scores = Transformer(image_features,
boxes) # Deformable-Attention modules

The training process, which may include a series of steps that iteratively continue until the generator is sufficiently successful at fooling/convincing the discriminator (e.g., if the discriminator is correct half of the time, which is what would be expected if the discriminator were simply “guessing” as to whether data is real or artificial), is represented in the following pseudocode of Table 3:

TABLE 3
Train step

```
# For each train_step
(image_A, boxes_A) from source datasets
translated_boxes = G(image_A, boxes_A)
# update G
minimize_G (D(image_A, translated_boxes_A) − 1) ** 2
# update D
(image_B, boxes_B) from target datasets
minimize_D (D(image_B, boxes_B) − 1) ** 2 + \
  (D(image_A, translated_boxes_A) − 0) ** 2 +
  MMD(image_A, image_B)
```

Example Problem Formulation: In various embodiments, for an image object detection dataset containing images x∈X and bounding boxes y∈Y, it can be assumed that the bounding boxes are labelled by a labelling function ƒ: X-Y. Each bounding box can contain box coordinates and a class attribute y={b, c}. Given two datasets D_{src} and D_{tgt} that share the same label space but come from different sources, the goal may be to learn a label translator G such that the translated labels from the source dataset is labelled in the same way as the target dataset, e.g., G (ƒ_{src} (x))=ƒ_{tgt} (x),x˜D_{src}. Supervised learning is not available in this problem since the labelling functions of both datasets are unknown, and getting empirical samples of ƒ_{tgt} (x),x˜D_{src} is itself challenging and often labor-intensive. A discussion of how to mitigate the learning challenge is provided under “Unsupervised Bounding Boxes Translation.”

Unsupervised Bounding Boxes Translation: In various embodiments, this may be approached by formulating the label translation problem as a GAN, using the discriminator D to discover the differences between the source and the target datasets and guide the learning of the generator (label translator) G (e.g., G (x_{src},y_{src}). The approach is further discussed under “Example 1” and Example 2″ below.
Example 1, Generator Updates: The generator can take the image and bounding boxes x_{scr}, y_{src} from the source dataset and can predict the change of each bounding box Ab, Ac. The output of the generator ŷ_{src} can be augmented with a set of randomly sampled background bounding boxes and then can be fed into the discriminator. In some embodiments, the generator can minimize the Least Squares GAN (LSGAN) objective. Example 1 is further illustrated in Table 4.

TABLE 4
Example 1

Input: (x_{src}, y_{src}) ~ D_{src}, (x_{tgt}, y_{tgt}) ~ D_{tgt}, y ~ D_{tgt}
GAN loss:
Δb_{src}, p(c_{src}) ← G_{θ}(x_{src}, y_{src}) {G Forward pass}
\hat{b}_{src} ← b_{src} + Δb_{src} {Compute box coordinates}
ĉ_{src} ← Gumble-Softmax p(c_{src})){Sample box class attribute}
ŷ_{src} ← (\hat{b}_{src}, ĉ_{src}) {Final boxes prediction}
y ← (b, bkg ), (b, c) = y {Replace class attribute with background}
ŝ_{src}, s ← D_{θ}(x_{src}, [ŷ_{src}, y]) {Compute discriminator scores}
${ℒ}_{lsgan}^{G} = \frac{1}{2} {( {\hat{s}}_{src} - 1 )}^{2} \{ LSGAN loss \}$
$θ ← θ - α \frac{{δℒ}_{lsgan}^{G}}{δθ} \{ Take a gradient step \}$

Example 2, Discriminator Updates: The fake pairs can come from the generator predictions and the real pairs can come from the discriminator. The predicted boxes ŷ_{src} and the bounding boxes from target y_{tgt} can be augmented with a set of randomly sampled background bounding boxes and then can be fed into the discriminator. In some embodiments, the discriminator can minimize the LSGAN objective. Example 2 is further illustrated in Table 5.

TABLE 5
Example 2

Input: xₛ rc, ŷ_{src},(x_{tgt}, y_{tgt}) ~ D_{tgt}, y₁ ~ D_{tgt}, y₂ ~ D_{tgt}
y₁ ← (b₁, bkg), (b₁, c₁ ) = y₁ {Replace class attribute with background}
y₂ ← (b₂, bkg ), b₂, c₂) = y₂
ŝ_{src}, s₁ ← D (x_{src} , [Ŷ_{src} , Y₁]) {Compute discriminator scores}
s_{tgt} , s₂ + D (X_{tgt}, [Ŷ_{tgt} , Y₂])
${ℒ}_{lsgan}^{D} = \frac{1}{2} ( {( {s}_{tgt} - 1 )}^{2} + {( {s}_{2} - 1 )}^{2} + {( {\hat{s}}_{src} - 0 )}^{2} )$
$ϕ ← ϕ - α \frac{{δℒ}_{lsgan}^{D}}{δϕ} \{ Take a gradient step \}$

The synthetic data, with translated labels, may be used to train various machine learning models, such as models for visual perception systems of autonomous or semi-autonomous vehicles.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one or more circuits to:
modify, using a neural network and based at least on images from a first dataset, one or more bounding regions of one or more labels corresponding to one or more images from the first dataset to obtain one or more modified bounding regions; and
update the one or more labels based at least on the modified bounding regions.

2. The processor of claim 1, wherein at least one label of the one or more labels comprises a bounding region surrounding one or more objects depicted in at least one image of the first dataset.

3. The processor of claim 2, wherein the one or more circuits are to modify the bounding region based on changes in pixels proximate to the bounding region between at least two different images of the first dataset.

4. The processor of claim 1, wherein the neural network is updated by:
using a generator to modify the one or more bounding regions in the one or more images of the first dataset;
using a discriminator to obtain a first score for the one or more images of the first data set and the modified bounding regions;
using a discriminator to obtain a second score for images of a second dataset and one or more bounding regions of the images of the second dataset; and
minimizing, using at least one of the first score or the second score, a first loss of the generator and a second loss of the discriminator.

5. The processor of claim 4, wherein the first dataset comprises images depicting synthetically generated data, and the second dataset comprises images of real objects or scenes.

6. The processor of claim 4, wherein the second loss comprises a function to minimize differences between the images of the first dataset and the images of the second dataset.

7. The processor of claim 1, wherein the one or more circuits are to:
identify pixels proximate to the bounding regions of the one or more images of the first dataset; and
modify, using the identified pixels, the bounding regions of the one or more images of the first dataset.

8. The processor of claim 1, wherein the neural network is a generative adversarial network (GAN).

9. The processor of claim 1, wherein at least one label of the one or more labels comprises a semantic or panoptic characterization of one or more objects in the bounding region.

10. The processor of claim 1, wherein at least one bounding region of the one or more bounding regions includes an identifiable object in a corresponding first image of the first dataset.

11. The processor of claim 1, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

12. A processor comprising:
one or more circuits to:
update a model to modify labels of first images in a source dataset, which includes:
using a generator to modify bounding regions of the first images;
using a discriminator to obtain a first score for the first images and the modified bounding regions, and a second score for second images in a reference dataset and bounding regions of the second images; and
minimizing a first loss of the generator and a second loss of the discriminator, using the first score and the second score.

13. The processor of claim 12, wherein the source dataset comprises synthetic data, and the reference dataset comprises real data.

14. The processor of claim 12, wherein the second loss comprises a function to minimize differences between the first images and the second images.

15. The processor of claim 12, wherein the one or more circuits are to:
identify pixels proximate to the bounding regions of the first images; and
modify the bounding regions of the first images, using the identified pixels.

16. The processor of claim 12, wherein the model is a generative adversarial network (GAN) model.

17. The processor of claim 12, wherein the one or more circuits are to use the updated model to modify the labels in the first images according to the modified bounding regions.

18. The processor of claim 17, wherein each label in the first images comprises a bounding region surrounding one or more objects, and wherein modifying the label in an image in the source dataset comprises modifying the bounding region.

19. The processor of claim 17, wherein modifying the bounding region comprises changing a shape or dimension of the bounding region.

20. A computer-implemented method comprising:
using a generative adversarial network (GAN) model to modify bounding regions in synthetic images, the bounding regions corresponding to objects in the synthetic images, the GAN model comprising a generator and a discriminator, the generator is to generate modified bounding regions, and the discriminator is to evaluate the modified bounding regions.
